(19) United States
(12) Patent Application Publication
(10) Pub. No.: US 2023/0063547 A1
(43) Pub. Date: Mar. 2, 2023

(54) System and Method for Virtual Tour Accessibility

(71) Applicant: Stephen D. Barnes, Atlanta, GA (US)

(72) Inventor: Stephen D. Barnes, Atlanta, GA (US)

(21) Appl. No.: 17/891,827

(22) Filed: Aug. 19, 2022

Related U.S. Application Data
(60) Provisional application No. 63/240,174, filed on Sep. 2, 2021.

(51) Int. Cl. G06T 19/00; G06F 3/01; G06F 3/04815

(52) U.S. Cl. CPC G06T 19/003; G06F 3/011; G06F 3/04815

(57) ABSTRACT

A computer system for electronically creating Americans with Disabilities Act (ADA) compliant virtual tours, comprising a non-transitory computer readable memory storing instructions and one or more processors when executing the instructions is configured to receive input from a user of a virtual tour, a point-of-interest, a name, and description associated with the point-of-interest, embed ADA compliant code in one or more files associated with the virtual tour related to the point-of-interest, name, and description, and execute the virtual tour including the embedded ADA compliant code.

### CROSS-REFERENCE TO RELATED APPLICATIONS

This patent application claims the benefit of U.S. Provisional Patent Application No. 63/240,174 filed Sep. 2, 2021 by Stephen D. Barnes entitled “System and Method for Virtual Tour Accessibility,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Virtual tours allow viewers to experience locations without actually being at that particular location. Viewers can use computers and mobile devices to access virtual tours of vacation destinations, tourist attractions, businesses, schools, real estate that for example is potentially for rent or sale, or a myriad of locations of interest to viewers. Virtual tours may include videos, still images, or images that are stitched together and are panoramically navigable by user of the subject location. Virtual tours include buttons, such as play, start, stop, and icons embedded in particular image locations to allow the user to selectively navigate to listen to and view different perspectives and views of the location.

### SUMMARY

In one embodiment, a computer system and method for electronically modifying, creating, and/or editing a virtual tour to include navigation and other features to assist a disabled user in experiencing the virtual tour is provided. In one embodiment, a computer system for electronically creating Americans with Disabilities Act (ADA) compliant virtual tours is provided, comprising a non-transitory computer readable memory storing instructions and one or more processors when executing the instructions is configured to receive input from a user of a virtual tour, a point-of-interest, a name, and description associated with the point-of-interest, embed ADA compliant code in one or more files associated with the virtual tour related to the point-of-interest, name, and description, and execute the virtual tour including the embedded ADA compliant code.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is one embodiment of a user interface of a player of the ADAC virtual tour system illustrating a view of a virtual tour with ADA compliant menus.

FIG. 2 is one embodiment of the user interface of the player of the ADAC virtual tour system illustrating another view of a virtual tour with a launch icon and point-of-interest.

FIG. 3 is one embodiment of the user interface of the player of the ADAC virtual tour system illustrating another view of a virtual tour with a point-of-interest.

FIG. 4 is one embodiment of a user interface of a dashboard of the ADAC virtual tour system for creating ADA compliant virtual tours.

FIG. 5 is one embodiment of the user interface of the dashboard of the ADAC virtual tour system for creating ADA compliant virtual tours.

FIG. 6 is a schematic illustration of the ADA compliant virtual tour system according to one embodiment.

FIG. 7 is a flow chart of a method for creating ADA compliant virtual tours according to one embodiment.

FIG. 8 is a diagram of one embodiment of a computer system capable of implementing the systems and methods described herein.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, virtual tours are widely available to view particular locations. However, virtual tours may be technically challenging to create and thus many businesses or other entities needing to create virtual tours must purchase or create software and systems to produce their own virtual tours or instead may turn to companies that specialize in producing virtual tours. These companies use cameras, videos, even drones equipped with cameras, to capture images of the subject location and then employ software and creative developers to produce the video tours. Many companies produce their own virtual tours and some companies specialize in producing or providing software and systems for creating virtual tours such as Matterport™, Kuula™, and others. Some of these companies may use or provide non-standard or proprietary systems and data file formats when producing the virtual tours, making them difficult for others to edit or modify.

Virtual tours provide a visual experience of the location and may include point-of-interest or way-points at specific locations in the tour that can be selected by a user to navigate through the virtual tour. However, virtual tours are not easily navigable and accessible to all users, such as a user with disabilities. In the United States, the Americans with Disabilities Act (ADA) provides standards for ensuring users with disabilities can navigate and access web content. The current ADA recommendations for enabling websites for disabled access are provided in the Web Content Accessibility Guidelines (WCAG) 2.1, which is incorporated herein by reference for all purposes. WCAG 2.1 provides recommendations and requirements for making content, such as virtual tours, more accessible to disabled users.

A business or entity my desire to ensure that their virtual tour complies with the ADA guidelines to broaden their audience of potential viewers but also because there may be legal requirements for doing so. Unfortunately, creating, editing, or modifying a virtual tour may be time-consuming and technically challenging.

The present disclosure provides a system and method for creating ADA compliant virtual tours. The system enables viewers of the virtual tour to engage an ADA accessible interface by, for example, selecting an icon which then serves the user with an ADA compliant (ADAC) version of the virtual tour. The ADAC version of the tour is substantially or, in some embodiments, exactly the same as the original virtual tour and follows all, substantially all, or in some cases many of the WCAG 2.1 best practices requirements and or recommendations.

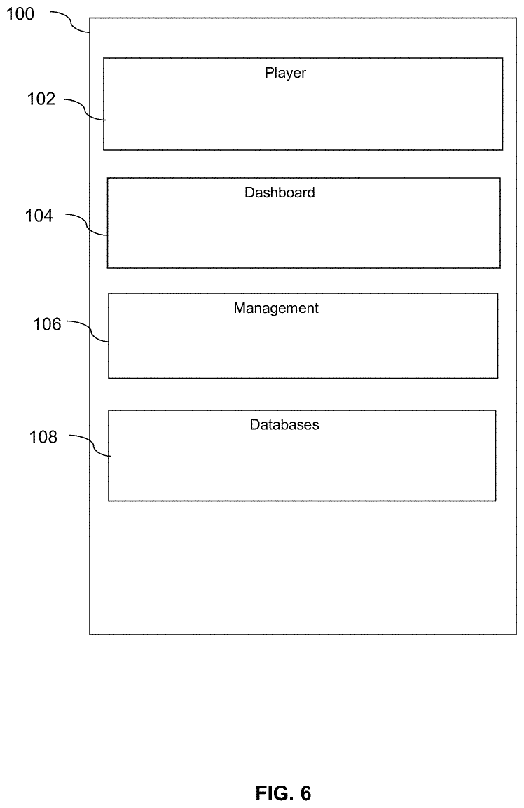

Referring to FIG. 6, the ADAC virtual tour system or just ADAC system 100 includes several components. The ADAC system 100 includes a number of main components each having various sub-components and/or features that will be described in further detail below. The ADAC system 100 may include: 1) a viewer or player 102, which may also be referred to as a virtual tour player or just player 102 for interacting with and viewing the ADAC virtual tours, (also referred to as the frontend system), 2) a dashboard 104 or tools for administering, creating, and enabling ADA compliant features in the virtual tours (also referred to as the backend system), 3) a management component 106 for administering subscription, payments, and so on for the system (also referred to as the e-commerce system), and 4) one or more databases 108 for storing associated data, as well as other components and features.

Player

It should be appreciated that a user may view an ADAC virtual tour that is created according to the systems and methods described herein without any additional or special software or systems. The ADAC virtual tours created as described herein are enabled, embedded, and/or coded, using techniques that will be discussed in more detail below, with the ADAC information and features such that, when the virtual tour is played or executed on a typical personal computer or mobile device, the ADAC features and information are available to the user. In order to view the ADAC features of the virtual tour, in some embodiments, the user merely selects an icon, indicated text, or otherwise indicating an ADAC version is available. To enable the reader features and have audio automatically played once the ADAC version is launched, the user may need to enable the user's computer screen reader, such as provided by Microsoft Windows™, JAWS™, as well as by other providers, which reads the embedded ADAC code and text in the virtual tour. In some embodiments, the player 102 may be a separate executable program or code overlaying the executable portions of the virtual tour, while in the present embodiment the player 102 may merely refer to execution by the user on the user's computer or device of the various code comprising the virtual tour and including and ADAC embedded codes and features therein. Once the user selects a launch icon, the virtual tour executes the ADAC embedded code and other data in addition to that which was in the original virtual tour.

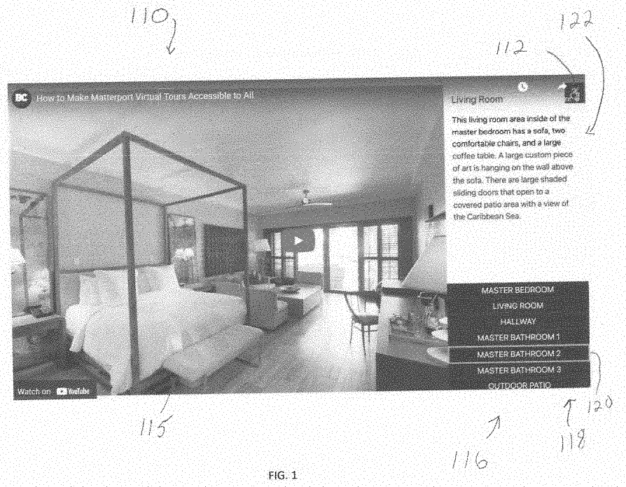

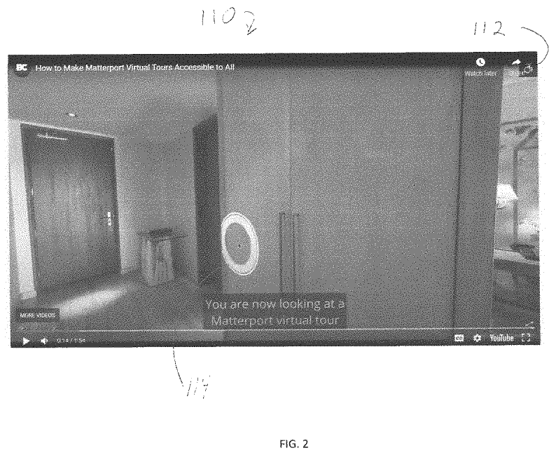

Referring to FIGS. 1 and 2, a window 110 or display screen is shown displaying a scene in a virtual tour that has been enabled with ADAC features according to the ADAC system 100. As mentioned above, when the virtual tour is executed or played, the player 102 (executable code) may display an icon, text, or other user selection that indicates that an ADA accessible version of the virtual tour is available. For example, in one embodiment, a launch icon 112 or other enabling component in the virtual tour enables the ADA compliant version of the virtual tour. FIG. 2 illustrates the window 110 displaying another scene in the virtual tour with the launch icon 112 before the launch icon has been selected. Thus, the virtual tour would be viewed as it would normally be viewed until the launch icon 112 is selected. FIG. 2 illustrates a non-ADA compliant version of the tour, where the user has not yet selected the launch icon 112, with a point-of-interest 114 or specific location in the virtual tour that a user can select, such as via mouse, to advance the virtual tour to a further location or view in the virtual tour.

Referring to FIG. 1, once the user selects the launch icon 112 from the virtual tour, the player 102 causes the virtual tour video to appear in a portion 115 of the window 110 and displays a user interface 116 adjacent the portion 115 of the virtual tour. While displayed on the right-most part of the window 110, the user interface 116 may be displayed at any location in the window 110. The user interface 116 includes a menu bar 118 and a description window 122 above the menu bar 118. The menu bar 118 includes a listing of locations corresponding to various points-of-interest in the virtual tour. In the view illustrated in FIG. 1, the menu item 120 with a text description of “Master Bedroom 2” is highlighted.

Selection of this menu item 120 by the user causes the player 102 to advance the virtual tour to the corresponding location for viewing. In addition, once the menu item 120 is selected, the player 102 displays, in the description window 122, text associated with the selected menu item 120. In this case, the text displayed in the description window 122 provides information about a living area inside the master bedroom.

It will be appreciated that the text displayed in the menu bar 118, the description window 122, and elsewhere may include specific font, font size, brightness, color, contrast, and so on which comply with the ADA and WCAG 2.1 requirements.

As previously mentioned, a user with disabilities may have difficulties operating computer systems in the same manner as other users without such disabilities. Accordingly, another feature enabled by the player 102 allows the user to navigate the virtual tour using, for example, keyboard arrows, tabs, spacebar, return key, or other keys, such as left and right, forward and backward, instead of requiring a mouse or other pointing device for navigation. Navigation via the keyboard is advantageous because a user with certain disabilities may have difficulties using a mouse or pointing device. Thus, the menu bar 118 of the user interface 116 is navigable via use of the keyboard keys. In the present embodiment, the user moves through the various options using the tab key and uses the enter key to select a particular option. Each time the user selects, via the menu bar 118, a different menu item 120, the player 102 advances to the associated portion of the virtual tour related to that point-of-interest 114 and displays the location's associated text in the description window 122. This allows individuals with disabilities to navigate through the virtual tour and learn about each location. In addition, users that are able to control a mouse or other pointer device may still select the various points of interest 114 and advance to the associated next point in the tour in the same way as in the non-ADA compliant version of the virtual tour.

For those individuals with hearing impairments that have enabled a screen reader, the player 102 prompts reading the text displayed in the description window 122, which text may correspond to all or some portion of the audio that would otherwise be played describing the information depicted at that portion of the virtual tour. The navigation features, audio reading of the displayed text, and so on implement compliance with the ADA and WCAG 2.1 requirements.

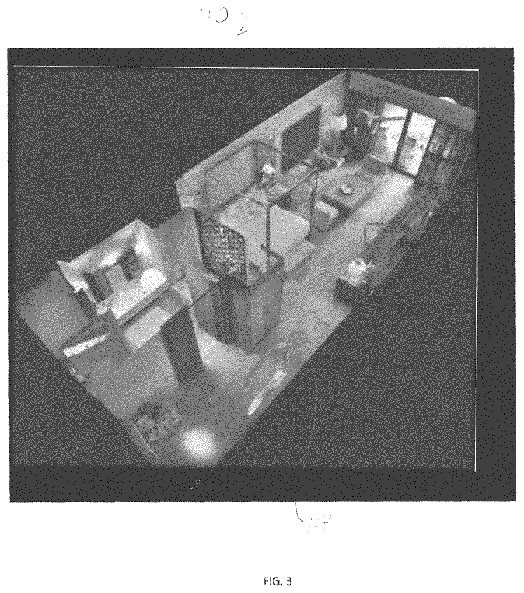

FIG. 3 illustrates another view of the window 110 displaying another view of the virtual tour in non-ADA compliant mode with another point-of-interest 114 location in the virtual tour that can be viewed using the player 102. The view illustrated in FIG. 3 is an example of a non-ADA compliant portion of the virtual tour that remains available to users that do not select the launch icon 112.

As can be seen from the above discussion, the ADAC system 100 enables a user with disabilities to easily launch and navigate through virtual tours since the ADAC virtual tour follows the WCAG 2.1 guidelines. In this way, users with disabilities can easily enjoy the experiences provided by virtual tours. The ADAC system 100 further allows other users to enjoy the virtual tours in non-ADA version as usual.

Dashboard

The dashboard 104 enables creation of ADAC virtual tours. The dashboard 104 includes a comprehensive suite of user interfaces and databases for creating ADAC virtual tours as well as administering the businesses or clients that desire to create or make their virtual tours ADA compatible. As discussed above, businesses and individuals may desire the ability to make their virtual tours ADA compliant. The ADAC system 100 provides the dashboard 104 which allows users, such as individuals desiring to create ADAC virtual tours, to log-in, create client accounts, link virtual tours that are not ADA compliant, and further provides tools for embedding code that enables the ADA compliant features and information in the linked virtual tour. The dashboard 104 also provides administrative features that allow an administrator of the ADAC system 100 to manage the user accounts and assist in the creation of ADAC virtual tours. Thus, the dashboard 104 includes numerous user interfaces and databases, only a few of which will be described in detail, while others will not be described in detail for reasons of brevity but will be appreciated as being included for operations, maintenance, and administration of the dashboard 104 by those skilled in the art.

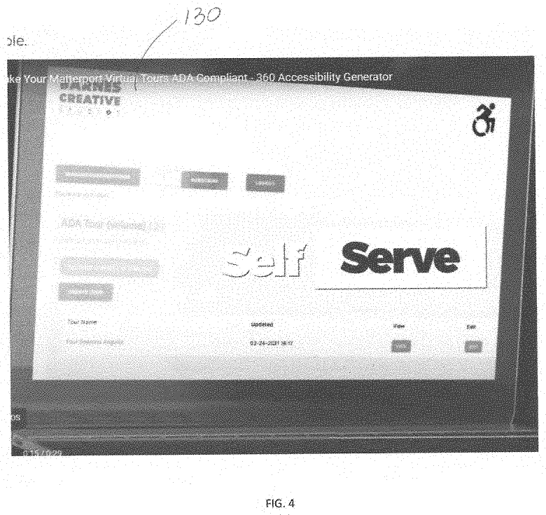

FIG. 4 illustrates examples of such features and shows a self-serve user interface 130 of the dashboard 104 for users to create ADAC virtual tours. Using interfaces such as user interface 130 and others interfaces and features of the dashboard 104, the user selects a virtual tour that the user desires to make ADA compliant. Once the particular virtual tour has been selected, for example by selecting the file or data containing the content of the virtual tour, the virtual tour may be linked or uploaded to the ADAC system 100.

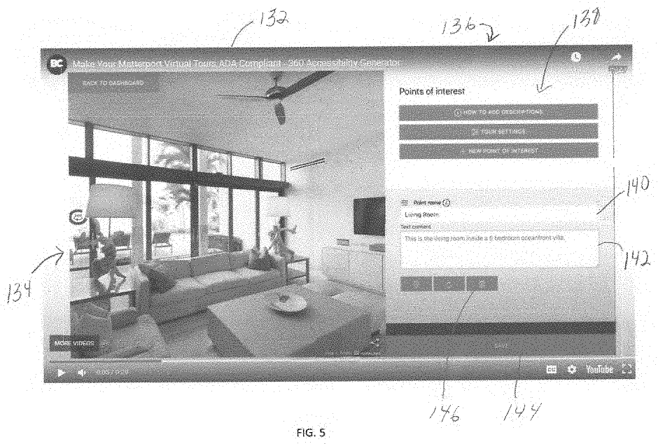

Once the user is ready to begin the process of creating the ADAC version of the particular virtual tour, referring to FIG. 5, the user launches a user interface 132. A portion 134 of the user interface 132 illustrates a scene in a virtual tour being displayed. The user interface 132 also includes a tool 136 which is a user interface that enables users to select points-of-interest in the virtual tour to embed with the ADAC features. The tool 136 includes a location portion 138 where the user or client selects a point-of-interest in the virtual tour to describe. These points-of-interest, in some embodiments, may have previously existed as part of the virtual tour and when selected might play an audio or other portion of the virtual tour to the user. Once a point-of-interest in the virtual tour has been created or selected, the user inputs a name or description identifying the point-of-interest via name input box 140, and adds a detailed description of the point-of-interest, via description input box 142. The name entered in name input box 140 may be “Living Room” or some other identifier of the point-of-interest which will be displayed by the player 102 as a menu item 120 on menu bar 118 of user interface 116 (FIG. 1) when the virtual tour is executed or played. Similarly, the description of the point-of-interest entered in description input box 142 will be displayed by the player 102 in the description window 122 of user interface 116 (FIG. 1) when the virtual tour is executed or played. Once completed, the user has the option to select to save 144 or delete 146 these descriptions.

The dashboard 104 includes programming that receives the user input including selection of a particular virtual tour, which includes the actual data file or files associated with the virtual tour, the location of the point-of-interest, name and description entered in input boxes 140 and 142, and embeds, labels, or codes this information into the selected virtual tour data file(s). The dashboard 104 embeds the code into the virtual tour in a manner that is identifiable or detectable by a screen reader, such as provided by Microsoft Window or other screen readers. In this way, when the virtual tour is later read or executed for viewing by a visiting user that has enabled the screen reader on the visiting user's computer or device, the embedded code appears substantially as discussed above with regard to the player 102 and execution of the virtual tour. That is, the ADAC features coded in the selected virtual tour appear when the virtual tour is executed or played.

The code embedded in the virtual tour data file(s) may include code that is executed when the virtual tour is played or run, including data or references to data in database(s) of the ADAC system 100. The embedded code includes code that provides the correct text, font size and type, color, brightness, contrast ratios, and so on to ensure the ADAC versions of the virtual tour substantially, mostly, or completely complies with the ADA requirements, for example, those provided in WCAG 2.1. Each item is coded into the virtual tour file(s) such that they will be automatically read or executed by enabled screen readers when the virtual tour is played. The codes embedded in the virtual tour by the dashboard 104 may, in one embodiment, be Accessible Rich Internet Application (ARIA) Tags which are a set of attributes that define ways to make web content and web applications accessible to individuals with disabilities. In other embodiments, other coding methods or formats may be used.

Furthermore, in some embodiments, the dashboard 104 further removes, replaces, or otherwise adapts the virtual tour data file(s) so as to prevent any non-ADA compliant elements from appearing when viewing the ADAC version of the virtual tour, such as disabling the audio portion of the virtual tour.

The data input by the user via the tool 136, including the selected point-of-interest, name, and descriptions of the point-of-interest, as well as any other or additional information used to enable ADAC virtual tours may be stored in one or more databases 108. The databases 108 may be stored in various locations such as the cloud, or elsewhere. Further, it will be appreciated that the actual coding for the navigation system may be provided by the dashboard 104 or provided by third party systems or software such as Visual360™.

The user or client creating the ADAC virtual tour using the dashboard 104 then continues to select other points-of-interest in the virtual tour and adds the name and description for each until all the desired points-of-interest have been updated or coded with the ADAC information as described above. It is noteworthy that the dashboard 104 adds the ADAC information to the virtual tour data file(s) in a manner that preserves the original virtual tour information which allows those later viewing the virtual tour to experience both the original, non-ADAC version of the virtual tour, or, via launching the ADAC version, experience the ADAC version of the virtual tour.

Thus, the dashboard 104 allows a user, clients, or creators to easily interact with and add content to points-of-interest in virtual tours that comply with the ADA requirements. Once valid and published, the virtual tour is ADA compliant and ready for use or consumption. The ADAC virtual tour may be stored in the database(s) 108 and accessed via the ADAC system 100 such that the ADAC system 100 implements the various components for navigation and so on to view the virtual tour but include the player 102 and or other systems as a layer or over-lay the virtual tour during execution to enable the ADAC version of the virtual tour. In other embodiments, the ADAC virtual tour may be embedded with all instructions and coded to run independently. When executed, the ADAC virtual tour runs substantially as described above with regard to the player 102.

The dashboard 104 also includes various user interfaces and options to enable clients to log in, upload, and edit virtual tours as described above. The dashboard 104 also allows an administrator of the dashboard 104 to upload and edit virtual tours as well as assist clients with editing the client's virtual tours. The administration portions of the dashboard 104 provide for organization of clients, client account details, and so on.

Management

The management component 106 provides additional features such as creating and managing client subscriptions and payment status, system security, and so on. The management component 106 may interface with one or more payment systems, and payment providers, such as Stripe™, to manage payment for use of the ADAC system 100 for making virtual tours ADAC. The management component 106 may handle a variety of other tasks, such as offering and providing access to demonstrations of the ADAC system 100, giving free trials, and so on for potential clients.

Database(s)

The data for the ADAC system 100 may be stored in one or more databases 108 in various locations, including the cloud. In some embodiments, data is stored in a content management system (CMS) and in some embodiments in so-called headless CMS.

Method

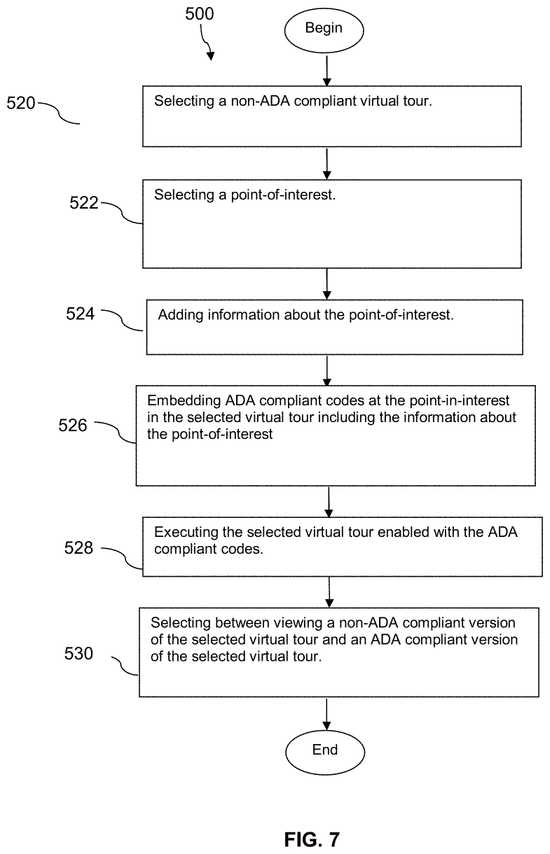

FIG. 7 illustrates a flow chart of one embodiment of a method 500 for editing virtual tours. The method 500 includes, at 520, selecting a virtual tour that is not ADAC in order to make the virtual tour ADAC. The method 500, at 522, includes selecting a point-of-interest in the virtual tour. The method 500, at 524, includes creating and adding information about the selected point-of-interest, such as a name and description. The method 500, at 526, includes embedding ADA compliant codes at the point-in-interest in the virtual tour including the information about the point-of-interest. The embedded codes include codes that, for example, execute an active screen reader and promote display of the information when the point-of-interest is selected. The method 500, at 528, includes executing or running the selected virtual tour with the ADA compliant codes. The method 500, at 530, includes selecting between viewing a non-ADA compliant version of the selected virtual tour and an ADA compliant version of the virtual tour.

Computer System

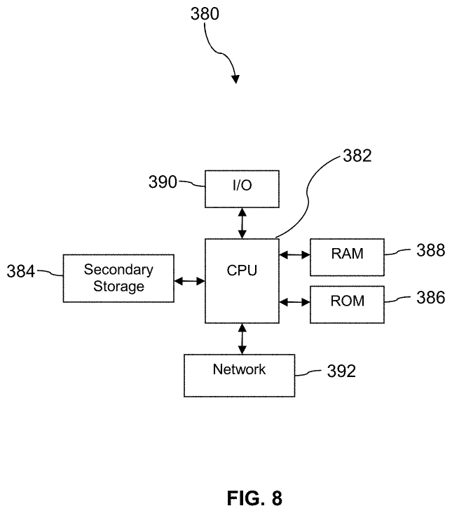

The ADAC system 100 may be implemented as a computer program or tool on a computer system or accessible by computer system via a web interface. As discussed above, the ADAC system 100 and the various subcomponents may be implemented as computer software applications or instructions executing on a computer system. FIG. 8 illustrates such a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID), and/or the like. The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A computer system for electronically creating Americans with Disabilities Act (ADA) compliant virtual tours, comprising:
a non-transitory computer readable memory storing instructions; and
one or more processors that upon execution of the instructions is configured to:
receive input from a user including selection of a virtual tour, a point-of-interest within the virtual tour, a name, and a description associated with the point-of-interest, and
embed ADA compliant code in one or more files associated with the virtual tour related to the point-of-interest, name, and description.

2. The computer system of claim 1, further wherein the processor is configured to execute the virtual tour including displaying at least one of the embedded ADA compliant codes.

3. The computer system of claim 1, wherein the one or more processors when executing the instructions is further configured to select, based on user input, between displaying a non-ADA compliant version of the virtual tour and an ADA compliant version of the virtual tour.

4. The computer system of claim 3, wherein the one or more processors when executing the instructions is further configured in response to the user selecting to view the non-ADA compliant version of the virtual tour to not display the embedded ADA compliant codes when playing the virtual tour.

5. The computer system of claim 3, wherein the one or more processors when executing the instructions is further configured to in response to the user selecting to view the ADA compliant version of the virtual tour to display the embedded ADA compliant codes when playing the virtual tour.

6. The computer system of claim 1, wherein the one or more processors when executing the instructions is further configured to:
display a tool interface including a widow to display a selected scene from virtual tour video; and
display a tool window comprising:
an input box for entry of the name associated point-of-interest, and
an input box for entry of the description associated with the point-of-interest.

7. The computer system of claim 6, wherein the one or more processors when executing the instructions is further configured to receive input from the user into the input boxes including the name, and the description of the point-of-interest.

8. The computer system of claim 3, wherein embedding the ADA compliant code in one or more files associated with the virtual tour related to the point-of-interest further comprises embedding the ADA compliant code such that the embedded code is associated with a position during in the virtual tour that coincides with the point-of-interest in the virtual tour.

9. A method for generating an Americans with Disabilities Act (ADA) compliant virtual tour, the method comprising:
receiving input of a selection of a point-of-interest in a virtual tour video;
receiving input of information about the point-of-interest in the virtual tour video; and
embedding ADA compliant data associated with the virtual tour video.

10. The method of claim 9, further comprising selecting one or more data files associated with the virtual tour video.

11. The method of claim 9, wherein inputting information about the point-of-interest in the virtual tour video further comprises:
displaying a tool interface including a widow to display a selected scene from the virtual tour video;
selecting the point-of-interest related to the displayed selected scene from the virtual tour video;
displaying a tool window comprising:
an input box for entry of the name associated point-of-interest, and
an input box for entry of the description associated with the point-of-interest; and
receiving the name and the description associated with the point-of-interest via the input boxes.

12. The method of claim 11, wherein embedding the ADA compliant data comprises embedding ADA compliant code such that the embedded ADA compliant code includes the name and the description associated with the point-of-interest and is associating the embedded ADA compliant code with a position during in the virtual tour that coincides with the point-of-interest in the virtual tour video.

13. The method of claim 9, further comprising:
receiving a selection to view a non-ADA compliant version of the virtual tour; and
displaying the virtual tour video without displaying the associated embedded ADA compliant codes.

14. The method of claim 9, further comprising:
receiving a selection to view an ADA compliant version of the virtual tour; and
displaying the virtual tour video including displaying the associated embedded ADA compliant codes.

15. The method of claim 9, wherein displaying the virtual tour video including displaying the associated embedded ADA compliant codes includes displaying an interface including a video window including at least a portion of the virtual tour video and an information window including information including a name, and a description associated with the portion of the virtual tour video being displayed by the video window.

16. The method of claim 15, wherein the portion of the virtual tour video displayed in the video window and the name and the description displayed in the information window are associated with a point-of-interest selected by a user.

17. The method of claim 15, further comprising receiving virtual tour video navigation input via keyboard input.

18. The method of claim 8, wherein generating the ADA compliant virtual tour comprises embedding one or more of codes associated with one or more files related to the virtual tour video, the one or more codes related to implementation of ADA video guidelines.
